(19) United States
(12) Patent Application Publication
(10) Pub. No.: US 2011/0182163 A1
(43) Pub. Date: Jul. 28, 2011

(54) OPTICAL PICKUP DEVICE

(75) Inventors: Wataru SATO, Hitachinaka (JP); Yoshihiro Sato, Yokohama (JP); Yusuke Kogure, Yokohama (JP)

(73) Assignee: HITACHI MEDIA ELECTRONICS CO., LTD.

(21) Appl. No.: 13/012,103

(22) Filed: Jan. 24, 2011

(30) Foreign Application Priority Data
Jan. 25, 2010 (JP) 2010-013055

(51) Int. Cl. G11B 7/12; G11B 33/02

(52) U.S. Cl. 369/75.11; 369/100; G9B/33.005; G9B/7.106

(57) ABSTRACT

The following problem associated with optical pickup devices is solved: the temperature of a laser element is increased by excessive temperature rise in a laser driver circuit and this degrades the quality of writing and reading information to and from an optical disc. In an optical pickup enclosure, there is formed a groove recessed into a U shape, extended from the upper surface thereof opposed to an optical disc to the lower surface of the optical pickup enclosure. An air guide passage through which an air flow is passed is formed of this groove recessed into a U shape and a circuit board fastened to the outer circumferential side of the optical pickup enclosure with a screw. At this time, the laser driver circuit element is attached to the side of the circuit board opposed to the air guide passage. In a radiation cover attached to the upper surface of the optical pickup enclosure and in thermal contact with the laser element, an opening is formed. This opening is substantially identical in shape with the aperture area in the air guide passage and is located in a position corresponding to the opening of the air guide passage in the upper surface of the optical pickup enclosure. Thus the air guide passage continues from the opening in the lower surface of the optical pickup enclosure to the surface opposed to the optical disc.

### BACKGROUND OF THE INVENTION

1. Field of the Invention

The present invention relates to an optical pickup device that writes and reads information to and from an optical disc.

2. Description of Related Art

Optical pickup device is a device that is equipped in an optical disc drive and controls laser light applied onto an optical disc when information is written to or read from the optical disc.

The optical pickup device is equipped with a laser element that oscillates a laser and a laser driver circuit element for controlling this laser element. The laser driver circuit element produces heat and thus its temperature rises when a laser is oscillated from the laser element.

With respect to the output characteristics of laser elements, they have such a temperature characteristic that a laser element is deteriorated at high temperature. Therefore, excessive temperature rise incurs degradation in the accuracy of writing/reading information. Further, it incurs degradation in the reliability of the optical pickup device, such as breakage. To cope with this, optical pickup devices are so designed as to prevent their temperature from exceeding a guaranteed temperature to protect the laser element.

Recent optical disc drives are required to write and read information at higher speeds. For this purpose, it is required to enhance the transfer rates for optical and electrical signals. To enhance the transfer rate of an optical pickup device, it is necessary to increase the outputs of the laser element and the laser driver circuit element.

As a result, temperature rise in elements due to increase in the amount of heat produced by laser elements and laser driver circuit elements has poses a more serious problem and the enhancement of heat radiation performance is indispensable.

To solve this problem, conventionally, a heat radiation structure has been adopted. In this structure, an opening is provided in the disc tray of an optical drive device and a rotational flow of air produced by the rotation of an optical disc is guided to the optical pickup device by this opening. The optical pickup device is thereby cooled.

For example, Patent Document 1 discloses a structure in which an air flow produced by the rotation of an optical disc is guided to an optical pickup device from a vent provided in a support portion for the optical pickup and heat is thereby radiated.

According to the technology disclosed in Patent Document 2, a ventilation hole is provided in a support plate for an optical disc drive. A swirling flow produced by variation in air pressure in the gap between an optical disc and the support plate is guided from this ventilation hole and the optical pickup device is thereby cooled.

The technology disclosed in Patent Document 3 does not utilize the structure of an optical drive device. A wide space is provided between a circuit board over which the laser driver circuit element of the optical pickup device is placed and the optical pickup enclosure and a rotational flow is guided into this space. The laser driver circuit element is thereby cooled.

As mentioned above, conventionally, the cooling of an entire optical pickup device is accelerated by guiding an air flow into the optical pickup device.

[Patent Document 1] Japanese Patent Laid-Open No. 2005-166218

[Patent Document 2] Japanese Patent Laid-Open No. 2005-310192

[Patent Document 3] Japanese Patent Laid-Open No. 2007-193861

It is known that temperature rise in a laser element largely depends on heating from a laser driver circuit element.

More specific description will be given. Heat produced by the laser driver circuit element is transmitted in the optical pickup device and raises the temperature around the laser element. Therefore, the laser element is influenced thereby.

Consequently, the following can be implemented by actively cooling the laser driver circuit element: the laser driver circuit element itself can be stably operated at a temperature not higher than a guaranteed temperature and further, temperature rise in the laser element can be suppressed.

However, providing a large space for guiding a rotational flow into an optical pickup causes a secondary problem. The strength of the optical pickup device is reduced and this degrades its reliability.

### SUMMARY OF THE INVENTION

It is an object of the invention to provide an optical pickup device in which it is possible to cool its laser driver circuit element without increasing the size of a space provided in the optical pickup and to prevent degradation in the reliability of the optical pickup device.

The above object is achieved as follows. An optical pickup device includes an optical pickup enclosure housing: a laser element to be a laser emission part; a laser driver circuit element that controls light emission by this laser element; a cover thermally coupled with the laser element; a circuit board mounted with the laser driver circuit element and fixed on a side surface of the optical pickup enclosure; an objective lens that collects laser light on an optical disc; and an objective lens driving apparatus that drives the objective lens. This optical pickup device is provided with a groove extended from the upper surface of the optical pickup enclosure opposed to the optical disc to the lower surface of the optical pickup enclosure. This groove is closed with the circuit board mounted with the laser driver circuit element to provide an air guide passage and the laser driver circuit element is positioned in the air guide passage.

Further, the above object is achieved by providing the cover opposed to the optical disc with an opening communicating with the air guide passage.

Further, the above object is achieved by reducing the sectional area of the air guide passage at the laser driver circuit element portion.

Further, the above object is achieved by forming the opening in the cover at a distance of not more than 3 mm from the optical disc.

Further, the above object is achieved by providing the opening provided in the cover with a cylindrical raised part and bringing the tip of the raised part close to the surface of the optical disc opposed thereto.

Further, the above object is achieved by providing the opening provided in the cover with a cylindrical raised part and providing the tip of the raised part with an air guide plate to the surface of the optical disc opposed thereto.

Further, the above object is achieved by forming the air guide passage of the circuit board.

According to the invention, the following optical pickup device can be provided: an optical pickup device in which the laser driver circuit element is cooled without increasing the size of a space provided in the optical pickup and degradation in the reliability of the optical pickup device is prevented.

### BRIEF DESCRIPTION OF THE DRAWINGS

FIG. 1 is a top view schematically illustrating the internal configuration of an optical disc drive 2 equipped with an optical pickup device 1;

FIG. 2 is a sectional view taken along line A-A′ of FIG. 1;

FIG. 3 is a perspective view illustrating an optical pickup device;

FIG. 4 is a sectional view taken along line A-A′ of FIG. 3;

FIG. 5 is a sectional view taken along line B-B′ of FIG. 4;

FIG. 6 is a perspective view illustrating an optical pickup device in a second embodiment;

FIG. 7 is a sectional view taken along line A-A′ of FIG. 6;

FIG. 8 is a sectional view taken along line B-B′ of FIG. 7;

FIG. 9 is a perspective view illustrating an optical pickup in a third embodiment;

FIG. 10 is a sectional view taken along line A-A′ of FIG. 9;

FIG. 11 is a graph chart indicating the result of computational fluid dynamics;

FIG. 12 is a perspective view illustrating an optical pickup in a fourth embodiment;

FIG. 13 is a sectional view taken along line A-A′ of FIG. 12;

FIG. 14 is a perspective view illustrating an optical pickup in a fifth embodiment;

FIG. 15 is a sectional view taken along line A-A′ of FIG. 14;

FIG. 16 is a perspective view illustrating an optical pickup in a sixth embodiment; and

FIG. 17 is a sectional view taken along line A-A′ of FIG. 16.

### DETAILED DESCRIPTION OF THE PREFERRED EMBODIMENTS

In general, cooling of a laser element itself has been carried out by bringing the laser element into thermal contact with a radiation cover comprising the optical pickup device. However, since the rate of writing/reading information was enhanced as mentioned above, the amount of heat produced by the laser element has been more and more increased. For this reason, it was found that heat was not sufficiently radiated just by bringing it into contact with the radiation cover.

The laser element itself naturally produces heat. In addition, the laser driver circuit element that controls the laser element also produces heat and it is negligible that this heat has influence on the laser element. To cope with this, a wind arising from the rotation of a disc could be directly applied to the laser driver circuit element to cool it. Since the wind is blown onto the laser driver circuit element, however, a problem arises. The entire optical pickup is shaken and this has harmful effect on the performance of the optical disc drive itself.

Consequently, the inventors of the invention laid open in this application paid attention to utilization of a pressure difference between the following: negative pressure produced on the front surface of an optical disc rotating at high speed in an optical disc drive and atmospheric pressure on the back surface side.

More specific description will be given. When an optical disc is rotated at high speed, a rotational wind is pushed toward the outer radius side. As a result, the flow rate of the air flow is increased and the disc surface is brought under slightly negative pressure. Meanwhile, the areas distant from the disc are under near atmospheric pressure. Therefore, consideration was given to utilizing a pressure difference between the area in proximity to the disc surface and the areas distant from the disc to cool the laser driver circuit element and thereby indirectly suppressing temperature rise in the laser element.

Before utilizing a pressure difference to efficiently guide cooling air to a laser element as mentioned above, the present inventors made various investigations and obtained the embodiments described below. Hereafter, description will be given to the details of the embodiments.

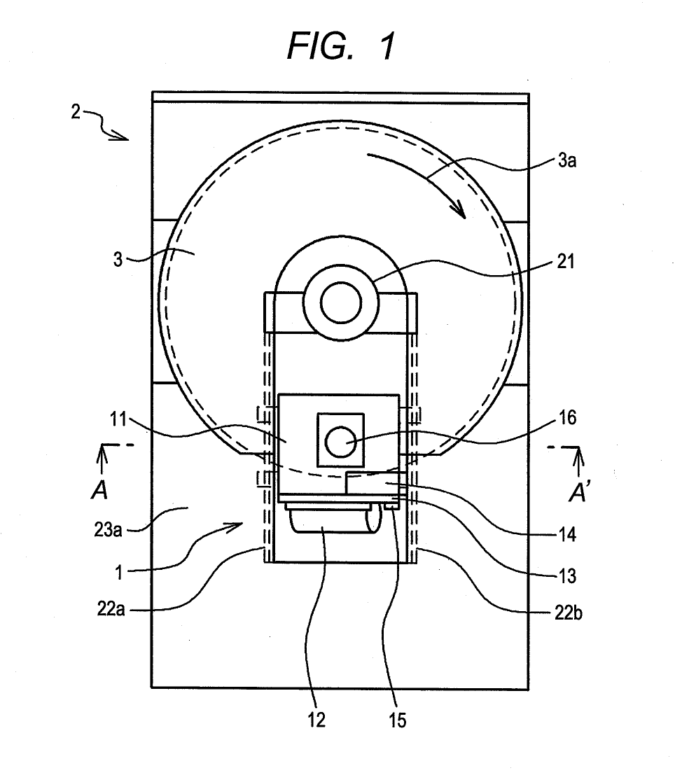

Before the embodiments are described, description will be given to the structure of an optical disc drive and an optical pickup with reference to FIG. 1 to FIG. 3.

FIG. 1 is a top view schematically illustrating the internal configuration of the optical disc drive 2 equipped with the optical pickup device 1.

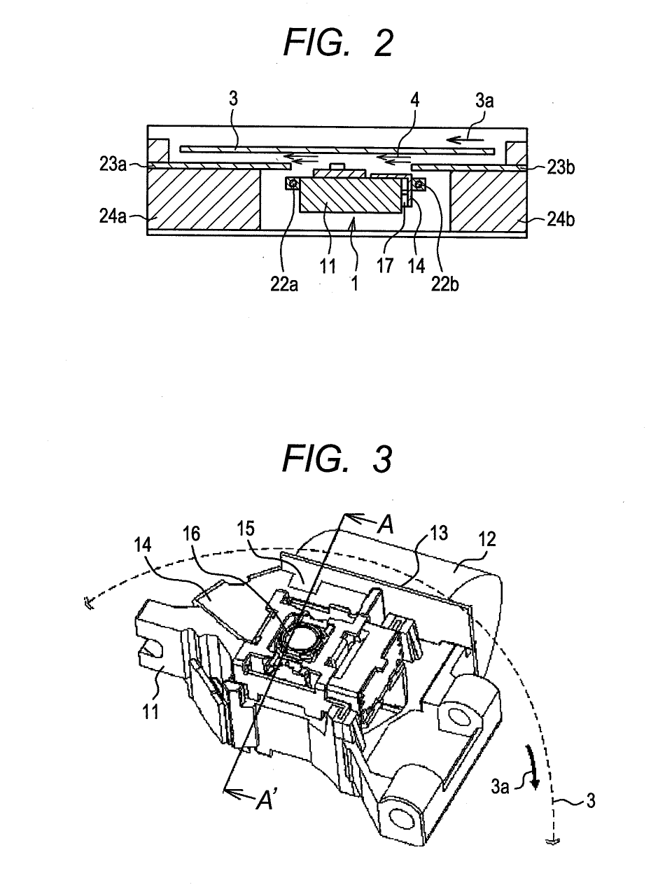

FIG. 2 is a sectional view taken along line A-A′ of FIG. 1.

FIG. 3 is a perspective view illustrating the optical pickup device.

In the optical disc drive 2 in FIG. 1 to FIG. 3, an optical disc 3 is rotated in the direction of rotation 3a by a spindle motor 21. The optical pickup 1 is placed under the cover 23 of the optical disc drive 2.

This optical pickup 1 is supported by guide shafts 22a, 22b provided in the optical disc drive 2. When performing read/write operation, the optical pickup 1 reciprocates along the guide shafts 22a, 22b between the inner radius side and the outer radius side. When the optical disc 3 is rotated, it is possible to read information on the optical disc 3 and write information.

At this time, an air flow 4 along the rotation direction 3a is produced by the rotation of the optical disc 3 as illustrated in FIG. 2 and it flows between the optical disc 3 and the optical pickup device 1.

On a side face of the optical pickup enclosure 11 forming the appearance of the optical pickup 1, there is fixed an laser element 17 to be a laser emission part for writing and reading information to and from the optical disc 3. Further, a laser element driver circuit 15 that controls light emission by the laser element 17 is fixed in thermal contact with the laser element 17.

As illustrated in FIG. 1, a circuit board 13 with the laser element driver circuit 15 attached thereto is attached to the upper surface of the optical pickup enclosure 11. In addition, the following are fixed: an objective lens 16 that collects laser light on the optical disc 3; an objective lens driving apparatus 16a (shown in FIG. 3) that drives the objective lens 16; and an optical detector and an optical unit (not shown). A radiation cover 14 radiates heat produced in the optical pickup device 1.

The optical pickup 1 is coupled to the optical disc drive 2 through a flexible substrate 12 attached to the circuit board 13. The laser element 17 and the radiation cover 14 are thermally coupled with each other and heat from the laser element 17 is radiated from the radiation cover 14 into the atmosphere.

In general, the material of each constituent element, for example, the optical pickup enclosure 11 is a metal die casting of magnesium, zinc, aluminum, or the like. In recent years, the materials are replaced by plastic for cost reduction. The circuit board 13 is formed of plastic containing copper wiring and the radiation cover 14 is formed of copper alloy, aluminum, or the like.

Hereafter, description will be given to a first embodiment with reference to the drawings.

### FIRST EMBODIMENT

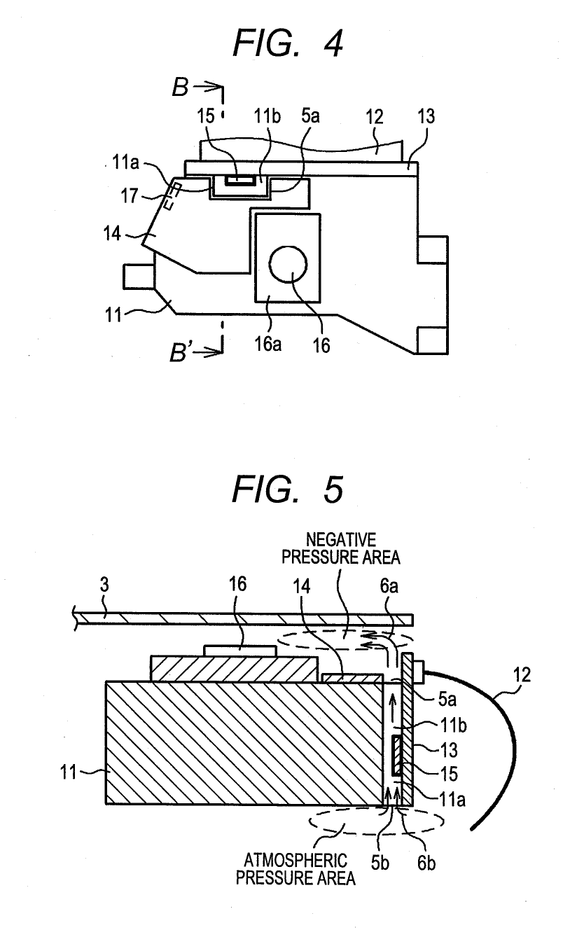

FIG. 4 is a sectional view taken along line A-A′ of FIG. 3.

FIG. 5 is a sectional view taken along line B-B′ of FIG. 4.

In the optical pickup 1 in FIG. 4 and FIG. 5, there is formed a groove 11a recessed into a U shape, extended from the upper surface opposed to the optical disc 3 to the lower surface of the optical pickup enclosure 11. The circuit board 13 is fastened with a screw on the outer circumferential side of the optical pickup enclosure 11 so that it covers the groove 11a recessed into a U shape. As the result of the circuit board 13 covering the groove 11a, an air guide passage 11b through which an air flow is passed is formed. At this time, the laser driver circuit element 15 is attached to the circuit board 13 on the side where it is opposed to the air guide passage 11b.

In the radiation cover 14 attached to the upper surface of the optical pickup enclosure 11, there is formed an opening 5a that makes an opening to the air guide passage 11b. In the lower surface of the optical pickup enclosure 11, there is formed an opening 5b communicating into the opening 5a. This opening 5b and the opening 5a opposed to the optical disc 3 are caused to communicate with each other through the air guide passage 11b. The air guide passage 11b is made a sort of tunnel-like ventilation flue substantially identical in shape by these openings 5a, 5b. For example, the following dimensions are acceptable for the groove 11a formed in the optical pickup enclosure 11: 3 mm in depth and 10 mm or so in width.

That is, this air guide passage 11b is a passage penetrating the optical pickup enclosure 11 so that the negative pressure area and the atmospheric pressure area encircled with broken lines in FIG. 5 communicate with each other.

Hereafter, description will be given to the action and effect obtained as the result of provision of this air guide passage 11b.

A very fast air flow 4 is produced in proximity to an optical disc 3 by the rotation of the optical disc 3 along the rotation direction 3a. The pressure is reduced in proximity to the surface of the optical disc by this fast flow. In positions distant from the optical disc 3, meanwhile, an air flow is very weak and thus slow and the pressure is atmospheric pressure or so. (With optical disc placement plate air guide passages 23a, 23b taken as the boundary, the area closer to the optical disc 3 is brought under negative pressure; and the area under the optical disc placement plate air guide passages 23a, 23b is brought under atmospheric pressure.) Reference numerals 24a and 24b denote an optical disc drive driving member.

From this phenomenon, an air flow 6a, 6b due to a pressure difference is produced in the air guide passage 11b formed in the optical pickup enclosure 11. The laser driver circuit element 15 attached to the circuit board 13 comprising the inner wall surface of the air guide passage 11b is actively cooled by the air flow 6a, 6b.

More specific description will be given. With the optical disc placement plate air guide passages 23a, 23b taken as the border, the area closer to the optical disc 3 is brought under negative pressure; and the area under optical disc placement plate air guide passages 23a, 23b is brought under atmospheric pressure. As a result, cooling air is caused to flow in from the opening 5b of the air guide passage 11b by this pressure difference. After cooling the laser driver circuit element 15, the air flows out of the opening 5a.

According to this embodiment, as mentioned above, temperature rise in the laser driver circuit element 15 is reduced. Therefore, excessive temperature rise in the laser element 17 is reduced and degradation in the reliability of the optical pickup device 1 can be prevented.

### SECOND EMBODIMENT

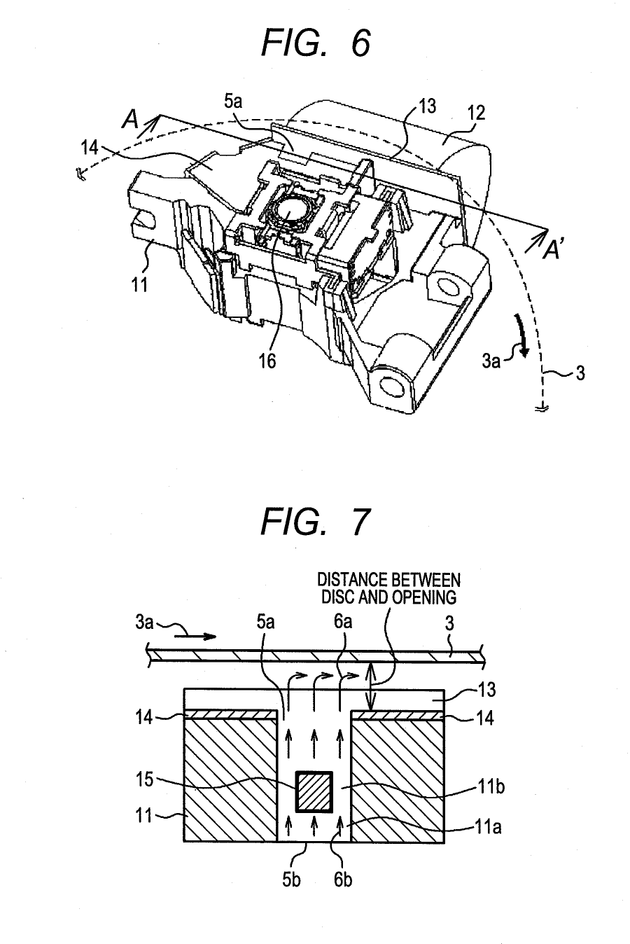

Description will be given to the second embodiment with reference to FIG. 6 to FIG. 8.

FIG. 6 is a perspective view illustrating an optical pickup device in the second embodiment.

FIG. 7 is a sectional view taken along line A-A′ of FIG. 6.

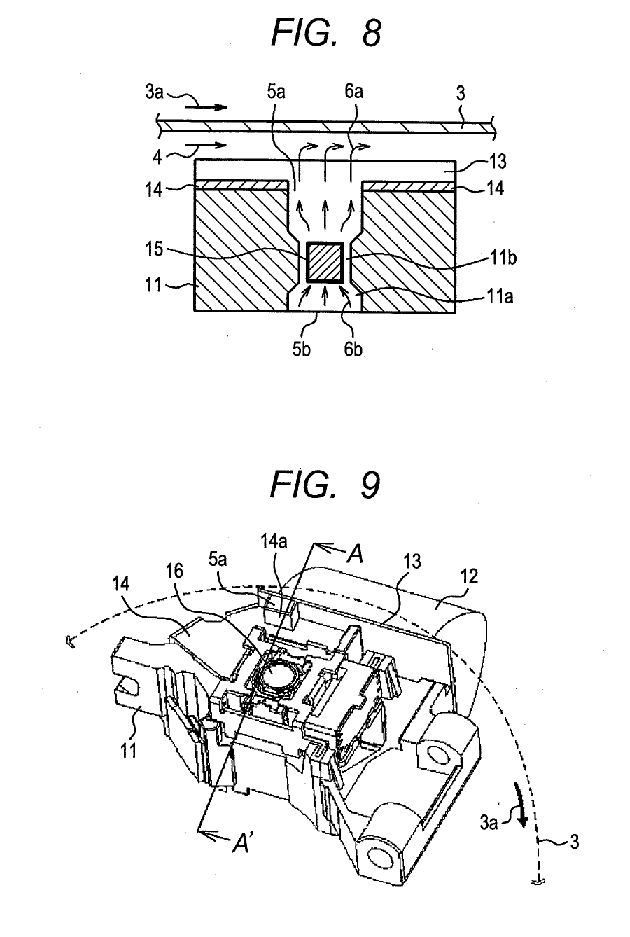

FIG. 8 is a sectional view taken along line B-B′ of FIG. 7.

In the second embodiment illustrated in FIG. 6, FIG. 7, and FIG. 8, the following groove is formed in the optical pickup enclosure 11 as in the first embodiment: a groove 11a recessed into a U shape, extended from the upper surface opposed to an optical disc 3 to the lower surface of the optical pickup enclosure 11. As the result of the groove 11a recessed into a U shape being covered with the circuit board 13, the air guide passage 11b through which an air flow is passed is formed. The circuit board 13 is fastened to the outer circumferential side of the optical pickup enclosure 11 with a screw.

At this time, the laser driver circuit element 15 is attached to the surface of the circuit board 13 opposed to the air guide passage 11b. In the radiation cover 14 attached to the upper surface of the optical pickup enclosure 11, there is formed the opening 5a of the air guide passage 11b in the upper surface of the optical pickup enclosure 11. In the lower surface of the optical pickup enclosure 11, the opening 5b is formed. The opening 5a substantially identical in shape with the aperture area in the air guide passage 11b is so formed that the air guide passage continues from the opening 5b to the surface opposed to the optical disc 3.

However, the air guide passage 11b provided in the optical pickup enclosure 11 need not be identical in sectional area with the opening 5a provided in the radiation cover 14 as illustrated in FIG. 7. As illustrated in FIG. 8, for example, the air guide passage 11b may be so structured that the sectional area of the air guide passage is reduced as it goes toward the laser driver circuit element 15.

According to this embodiment, the flow rate of air guided to the vicinity of the laser driver circuit element 15 in the air guide passage 11b is increased. This makes it possible to reduce temperature rise in the laser driver circuit element 15 to reduce excessive temperature rise in the laser element 17. Therefore, degradation of the reliability of the optical pickup device 1 can be prevented.

### THIRD EMBODIMENT

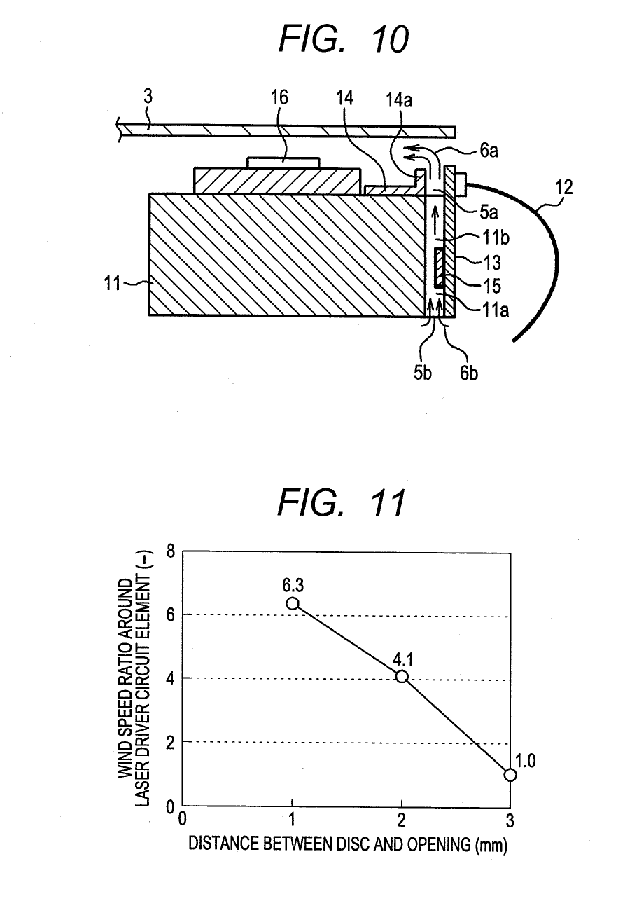

Description will be given to the third embodiment with reference to FIG. 9 and FIG. 10.

FIG. 9 is a perspective view illustrating an optical pickup in the third embodiment.

FIG. 10 is a sectional view taken along line A-A′ of FIG. 9.

In the third embodiment illustrated in FIG. 9 and FIG. 10, the following groove is formed in the optical pickup enclosure 11 as in the first embodiment: a groove 11a recessed into a U shape, extended from the upper surface opposed to an optical disc 3 to the lower surface of the optical pickup enclosure 11. As the result of the groove 11a recessed into a U shape being covered with the circuit board 13, the air guide passage 11b through which an air flow is passed is formed. The circuit board 13 is fastened to the outer circumferential side of the optical pickup enclosure 11 with a screw.

At this time, the laser driver circuit element 15 is attached to the surface of the circuit board 13 opposed to the air guide passage 11b. In the radiation cover 14 attached to the upper surface of the optical pickup enclosure 11, there is formed the opening 5a of the air guide passage 11b in the upper surface of the optical pickup enclosure 11. In the lower surface of the optical pickup enclosure 11, the opening 5b is formed. The opening 5a substantially identical in shape with the aperture area in the air guide passage 11b is so formed that the air guide passage continues from the opening 5b to the surface opposed to the optical disc 3.

However, the opening 5a in the radiation cover 14 may be brought closer to the optical disc 3 than the surface of the radiation cover 14 opposed to the objective lens. In this case, the radiation cover 14 is provided with a cylindrical raised part to form a radiation cover duct 14a. The radiation cover duct 14a is so structured that it is substantially identical in sectional shape with the air guide passage 11b formed in the optical pickup enclosure 11. This brings the opening 5a closer to the surface of the optical disc 3. As seen from FIG. 9, the radiation cover duct 14b comprises the raised part together with the circuit board 13.

Since an air flow produced by rotation is more accelerated as it goes closer to the optical disc 3, the pressure is more reduced. For example, the opening 5a is extended to the same height as that of the objective lens 16 to set the distance between the optical disc 3 and the opening 5a to 1 mm. This makes it possible to enhance the flow rate of an air flow 6a, 6b in the air guide passage 11b. Formation of the duct 14a increases the surface area of the radiation cover 14. As a result, the heat radiation performance for the laser element 17 is also enhanced and temperature rise in the laser element 17 can be suppressed. Therefore, the enhancement of the reliability of the optical pickup device 1 can be achieved.

The present inventors estimated the value of air flow rate in the air guide passage 11b in the third embodiment by computational fluid dynamics (CFD) as indicated in FIG. 11.

FIG. 11 is a graph chart indicating the result of the computational fluid dynamics.

From FIG. 11, it was verified that following takes place when the number of rotations of an optical disc is 9000 rpm (the air flow rate is 7.5 m/s in the outer radius area of the disc): in this embodiment, the value of air flow rate around the laser driver circuit element 15 in the air guide passage 11b formed in the optical pickup enclosure 11 depends on the distance between the optical disc 3 and the opening 5a; and when this distance is set to 1 mm, the flow rate value is increased to 6.3 times the value obtained when the distance between the optical disc 3 and the opening 5a is set to 3 mm.

### FOURTH EMBODIMENT

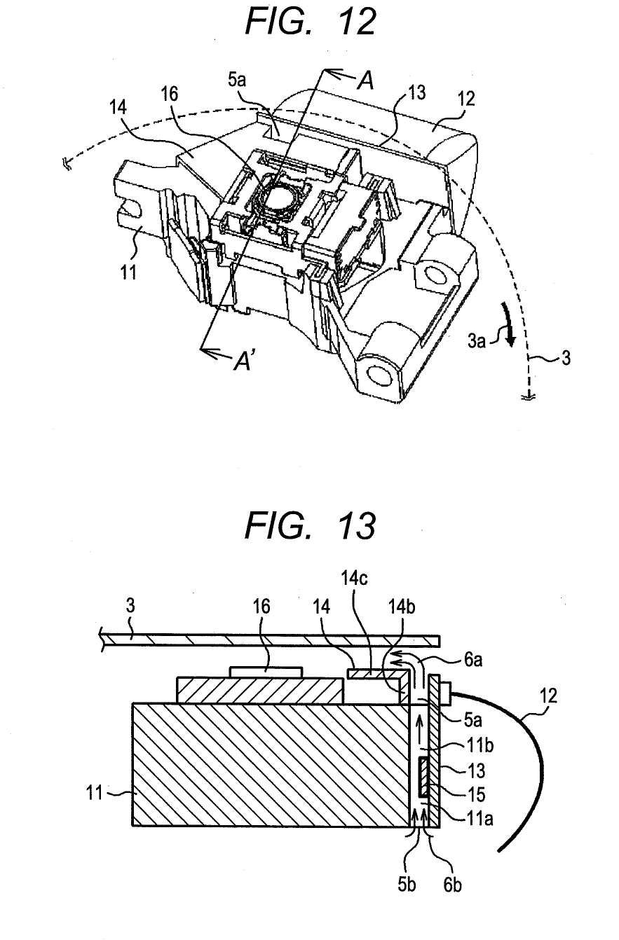

Description will be given to the fourth embodiment with reference to FIG. 12 and FIG. 13.

FIG. 12 is a perspective view illustrating an optical pickup in the fourth embodiment.

FIG. 13 is a sectional view taken along line A-A′ of FIG. 12.

In the fourth embodiment, the following groove is formed in the optical pickup enclosure 11 as in the first embodiment: a groove 11a recessed into a U shape, extended from the upper surface opposed to an optical disc 3 to the lower surface of the optical pickup enclosure 11. As the result of the groove 11a recessed in to a U shape being covered with the circuit board 13, the air guide passage 11b through which an air flow is passed is formed. The circuit board 13 is fastened to the outer circumferential side of the optical pickup enclosure 11 with a screw.

At this time, the laser driver circuit element 15 is attached to the surface of the circuit board 13 opposed to the air guide passage 11b. In the radiation cover 14 attached to the upper surface of the optical pickup enclosure 11, there is formed the opening 5a of the air guide passage 11b in the upper surface of the optical pickup enclosure 11. In the lower surface of the optical pickup enclosure 11, the opening 5b is formed. The opening 5a substantially identical in shape with the aperture area in the air guide passage 11b is so formed that the air guide passage continues from the opening 5b to the surface opposed to the optical disc 3.

However, the radiation cover 14 need not be placed in proximity to the upper surface of the optical pickup enclosure 11. For example, the radiation cover 14 may be attached in a position closer to the optical disc 3 than to the upper surface of the optical pickup enclosure 11. In this case, a radiation cover duct 14b substantially identical in shape with the aperture area in the air guide passage 11b formed in the optical pickup enclosure 11 is formed. The air guide passage 11b and the opening 5a in the radiation cover 14 are thereby caused to communicate with each other. As seen from FIG. 13, the radiation cover duct 14b comprises a raised part together with the circuit board 13. Part 14c of the radiation cover 14 makes an air guide plate to the surface of the optical disc opposed to the tip of this raised part.

The structure in which the radiation cover 14 is attached in a position closer to the optical disc 3 makes the opening 5a closer to the optical disc 3. Therefore, the flow rate of a rotational flow 4 produced by the rotation of the optical disc 3 is increased and this leads to reduced pressure at the opening 5a. For this reason, the pressure difference between the opening 5a and the opening 5b is increased. As a result, the flow rate of an air flow 6a, 6b produced in the air guide passage 11b is increased and the heat radiation performance of the laser driver circuit element 15 is enhanced.

Further, the flow rate of a rotational flow 4 passed along the surface of the radiation cover 14 is also increased. As a result, the heat radiation performance of the radiation cover 14 is increased and temperature rise in the laser element 17 can be reduced. Therefore, degradation in the reliability of the optical pickup device 1 can be prevented.

### FIFTH EMBODIMENT

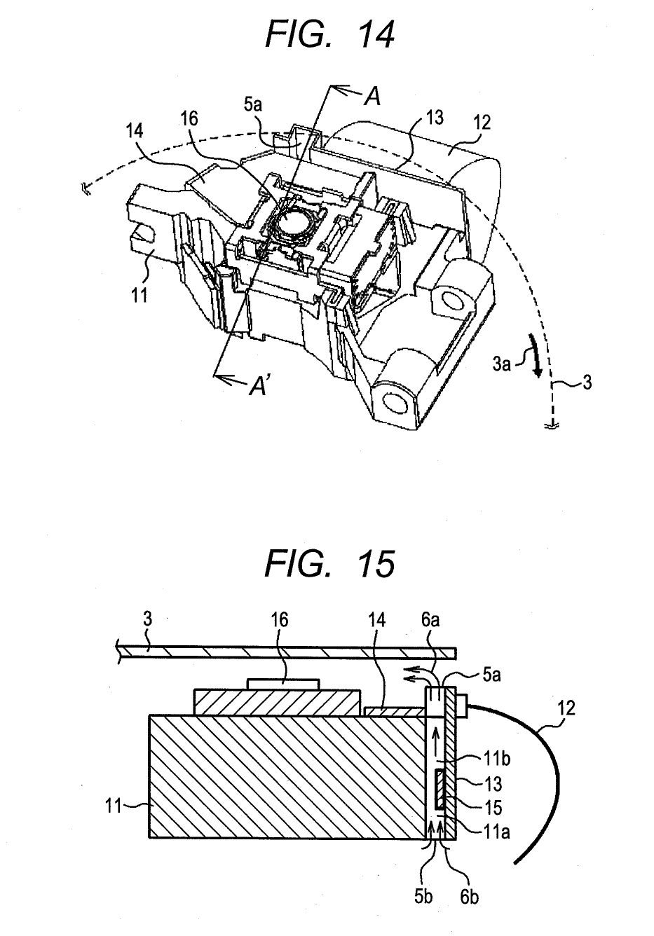

Description will be given to the fifth embodiment with reference to FIG. 14 and FIG. 15.

FIG. 14 is a perspective view illustrating an optical pickup in the fifth embodiment.

FIG. 15 is a sectional view taken along line A-A′ of FIG. 14.

In the optical pickup device 1 illustrated in FIG. 14 and FIG. 15, the space formed in the air guide passage 11b need not be formed of a recessed portion of the optical pickup enclosure 11. Instead, the following measure may be taken: a recessed portion is formed of the circuit board 13 and the space formed by a side face of the optical pickup enclosure 11 and the recessed portion of the circuit board 13 is taken as the air guide passage 11b.

FIG. 15 illustrates how the air guide passage 11b is formed by forming a U-shaped portion in the circuit board 13. When a U-shaped portion is formed in the circuit board 13 as mentioned above, three faces of the air guide passage 11b are formed by the circuit board 13. Therefore, the U-shaped inner surface of the circuit board 13 can be considered as the enlarged heat transfer surface of the laser driver circuit element 15. Further, since the laser driver circuit element 15 can be positioned away from the laser element 17, temperature rise in the laser element 17 can be prevented. Heat radiation from the laser driver circuit element 15 can be accelerated by an air flow passed through the air guide passage 11b. Therefore, temperature rise in the laser element 17 can be suppressed and degradation in the reliability of the optical pickup device 1 can be prevented.

### SIXTH EMBODIMENT

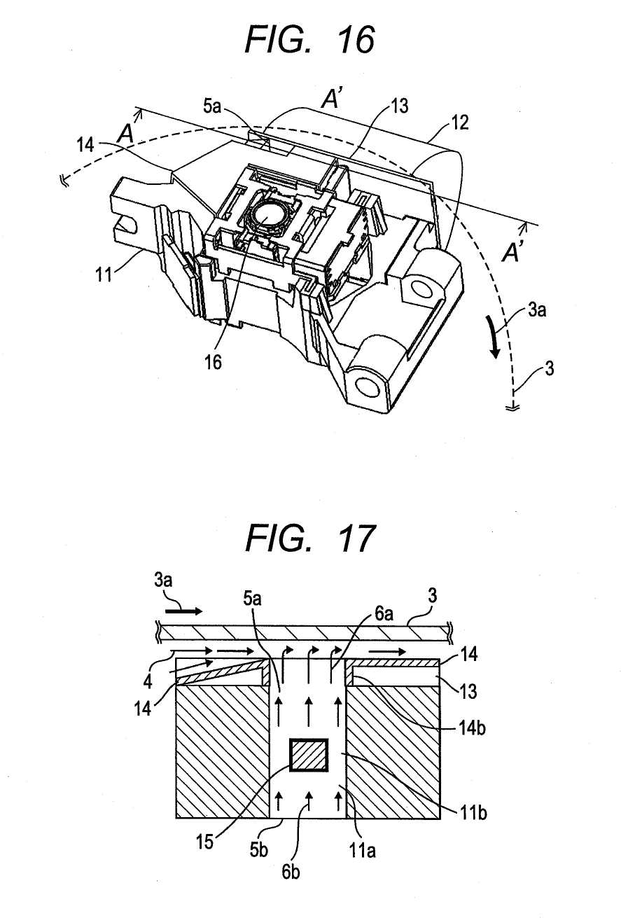

Description will be given to the sixth embodiment with reference to FIG. 16 and FIG. 17.

FIG. 16 is a perspective view illustrating an optical pickup in the sixth embodiment.

FIG. 17 is a sectional view taken along line A-A′ of FIG. 16.

In the sixth embodiment, the following groove is formed in the optical pickup enclosure 11 as in the first embodiment: a groove 11a recessed into a U shape, extended from the upper surface opposed to an optical disc 3 to the lower surface of the optical pickup enclosure 11. As the result of the groove 11a recessed into a U shape being covered with the circuit board 13, the air guide passage 11b through which an air flow is passed is formed. The circuit board 13 is fastened to the outer circumferential side of the optical pickup enclosure 11 with a screw.

At this time, the laser driver circuit element 15 is attached to the surface of the circuit board 13 opposed to the air guide passage 11b. In the radiation cover 14 attached to the upper surface of the optical pickup enclosure 11, there is formed the opening 5a of the air guide passage 11b in the upper surface of the optical pickup enclosure 11. In the lower surface of the optical pickup enclosure 11, the opening 5b is formed. The opening 5a substantially identical in shape with the aperture area in the air guide passage 11b is so formed that the air guide passage continues from the opening 5b to the surface opposed to the optical disc 3.

However, the radiation cover 14 need not be placed in parallel with the optical disc 3. As illustrated in FIG. 17, for example, the radiation cover 14 may be so structured that the distance between the radiation cover and the optical disc 3 is reduced as it goes toward the opening 5a.

In this case, a duct 14b substantially identical in shape with the aperture area in the in the air guide passage 11b formed in the optical pickup enclosure 11 is formed. The air guide passage 11b and the opening 5a in the radiation cover 14 are thereby caused to communicate with each other.

According to this embodiment, the flow rate of a rotational flow 4 at the opening 5a provided in the radiation cover 14 is increased and as a result, the pressure at the opening 5a is reduced. This increases the pressure difference between the opening 5a and the opening 5b. As a result, the flow rate of an air flow 6a, 6b produced in the air guide passage 11b is increased and the heat radiation performance of the laser driver circuit element 15 is enhanced.

Further, the flow rate of a rotational flow 4 passed along the surface of the radiation cover 14 is also increased. As a result, the heat radiation performance of the radiation cover 14 is increased and temperature rise in the laser element 17 can be reduced. Therefore, degradation in the reliability of the optical pickup device 1 can be prevented.

According to the invention, as described up to this point, the following are coupled with each other through an air guide passage formed by a groove in the optical pickup enclosure and the laser driver circuit board: the negative pressure area in proximity to an optical disc produced by the rotation of the optical disc and the atmospheric pressure portion located at the lower part of the optical pickup device. An air flow is produced in the air guide passage by this pressure difference and the air flow is guided directly to the laser driver circuit element placed in the air guide passage and heat radiation from the laser driver circuit element is thereby accelerated. The heat radiation performance of the laser driver circuit element is thereby enhanced to suppress excessive temperature rise in the laser element. As a result, the reliability of the optical pickup device can be enhanced.

In the above description, an optical pickup equipped with one laser element has been taken as examples of embodiments. However, those equipped with two laser elements, a laser element for CD and a laser element for DVD, have become the mainstream of actual products. Even in this case, these embodiments can be adopted.

Further, some models are equipped with a laser element for BD (Blu-ray Disc). Both the laser elements for CD and the laser elements for DVD are red laser elements and either can be used for both cases. Therefore, two laser elements are equipped as in the above case. Even in this case, these embodiments can be adopted.

What is claimed is:

1. An optical pickup device comprising an optical pickup enclosure housing:
a laser element to be a laser emission part;
a laser driver circuit element controlling light emission by this laser element;
a cover thermally coupled with the laser element;
a circuit board mounted with the laser driver circuit element and fixed on a side face of the optical pickup enclosure;
an objective lens collecting laser light on an optical disc; and
an objective lens driving apparatus driving this objective lens,
wherein a groove extended from the upper surface of the optical pickup enclosure opposed to the optical disc to the lower surface of the optical pickup enclosure is provided and this groove is closed with the circuit board mounted with the laser driver circuit element to provide an air guide passage, and
wherein the laser driver circuit element is positioned in the air guide passage.

2. The optical pickup device according to claim 1,
wherein the cover opposed to the optical disc is provided with an opening communicating with the air guide passage.

3. The optical pickup device according to claim 1,
wherein the sectional area of the air guide passage is reduced at the portion where the laser driver circuit element is mounted.

4. The optical pickup device according to claim 1,
wherein the opening in the cover is formed at a distance of not more than 3 mm from the optical disc.

5. The optical pickup device according to claim 1,
wherein the opening provided in the cover is provided with a cylindrical raised part and the tip of this raised part is brought close to the surface of the optical disc opposed thereto.

6. The optical pickup device according to claim 1,
wherein the opening provided in the cover is provided with a cylindrical raised part and an air guide plate to the surface of the optical disc opposed to the tip of this raised part is provided.

7. The optical pickup device according to claim 1,
wherein the air guide passage is formed of the circuit board.
